(19) United States
(12) Patent Application Publication
(10) Pub. No.: US 2025/0328856 A1
(43) Pub. Date: Oct. 23, 2025

(54) FORECASTING ORDERS FOR DIVERSE SET OF TIME SERIES DATASETS AT GRANULAR LEVEL USING GRAPH STRUCTURE AND GENERATIVE MODELLING

(71) Applicant: Ell Products L.P., Round Roack, TX (US)

(72) Inventors: Saurabh Jha, Austin, TX (US); Atul Mittal, Bangalore (IN); Kuruba Ajay Kumar, Anantapur (IN)

(21) Appl. No.: 18/638,061

(22) Filed: Apr. 17, 2024

(51) Int. Cl. G06Q 10/087

(52) U.S. Cl. CPC G06Q 10/087

(57) ABSTRACT

A method for managing order processing includes obtaining a set of time series datasets associated with the order processing for an order processing system, generating an adjacency matrix using the set of time series datasets and using a recurrent neural network (RNN), applying a graphical Fourier transformation on the adjacency matrix using a Laplacian matrix and an inverse graph Fourier to obtain a graph Fourier transform, applying a sequential network on the graph Fourier transform using a fast Fourier transform network and a convolution layer to obtain output features, performing a generative modeling on the output features to generate a forecasting sequence, and initiating an agent deployment of a plurality of agents on the order processing system based on the forecasting sequence, wherein the plurality of agents each provide services associated with order processing.

### BACKGROUND

Order processing and query incident management are branches of a corporate entity that manage the purchases between customers and the corporate entity. The corporate entity may manage the deployment of agents for the purposes of managing resources used for order processing.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of an order forecasting manager in accordance with one or more embodiments of the invention.

FIG. 3 shows a flowchart of a method of generating forecasting models in accordance with one or more embodiments of the invention.

FIGS. 4.1-4.2 show an example in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or preceded) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments disclosed herein include methods and systems for managing order processing of a corporate entity. Embodiments disclosed herein include tracking the number of orders processed over a period of time for multiple epicenters (e.g., branches of the corporate entity), storing each of the tracked number of orders as a time series dataset. The set of time series datasets may include combinations of independent and identically distributed (IID) and non-IID datasets. A processing of the set of time series datasets in accordance with one or more embodiments of the invention includes generating an adjacency matrix corresponding to the set of time series datasets, applying a generative modelling on the adjacency matrix to generate a set of forecasting sequences. The forecasting sequences may be optimized using an error modeling to obtain finalized forecasting models. The finalized forecasting models may be used to manage the agent deployment used for the order processing of future orders. For example, for a forecasting sequence indicating a relatively high number of orders for a given period of time (e.g., a week), an order forecasting manager may increase a number of order processing agents deployed for the given period of time.

The following describes various embodiments of the invention.

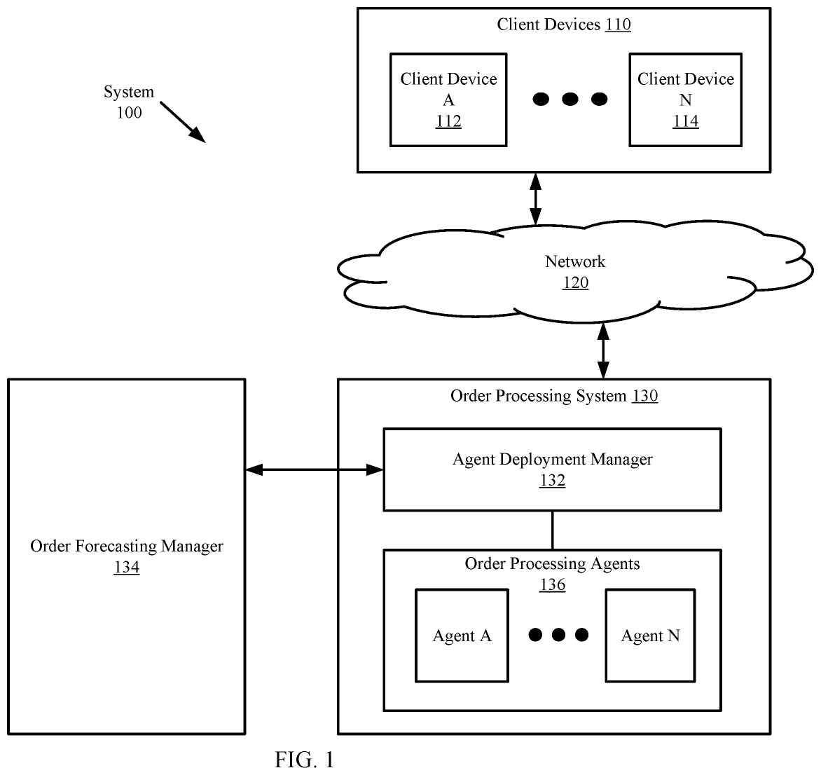

FIG. 1 shows a system in accordance with one or more embodiments of the invention. The system (100) includes any number of client devices (110), a network (120), an order processing system (130), and an order forecasting manager (134). The system (100) may include additional, fewer, and/or different components without departing from the scope of the invention. Each component may be operably connected to any of the other component via any combination of wired and/or wireless connections. Each component illustrated in FIG. 1 is discussed below.

In one or more embodiments of the invention, the order processing system (130) may provide computer-implemented services to users. The computer-implemented services may include deploying order processing agents (136) (also referred to as processing agents (136)) that aid in communicating with the client devices (110) to process orders for new products. Examples of computer-implemented services include transactions for purchasing the new products, customer support systems (such as online chat services), tracking and managing inventory, initiating shipping of products, order tracking, managing customer communication with the client devices (112, 114), and providing information to the client devices (110) that include information about previous orders, transaction information associated with current, past, or future orders, and/or any other information associated with the processing of one or more orders.

The volume of orders may impact the required number of order processing agents (136). In one or more embodiments, the processing of orders are performed using order processing agents (136) of the order processing system. The order processing agents (136) may each include functionality to communicate with the client devices (110) to provide the aforementioned services based on products offered by a corporate entity managing the order processing system (130).

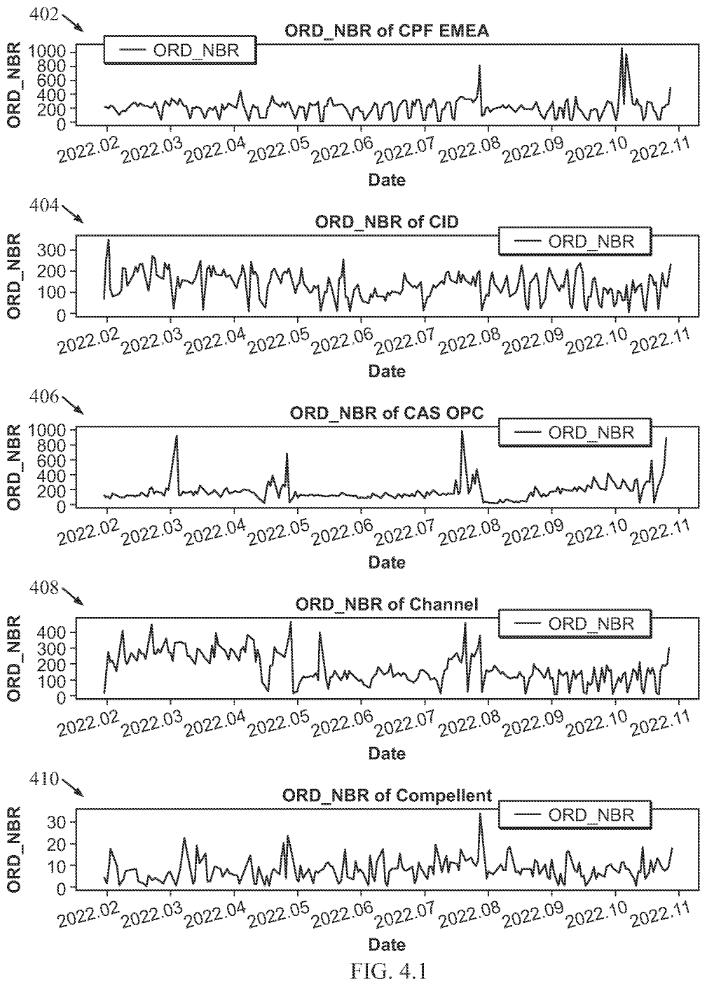

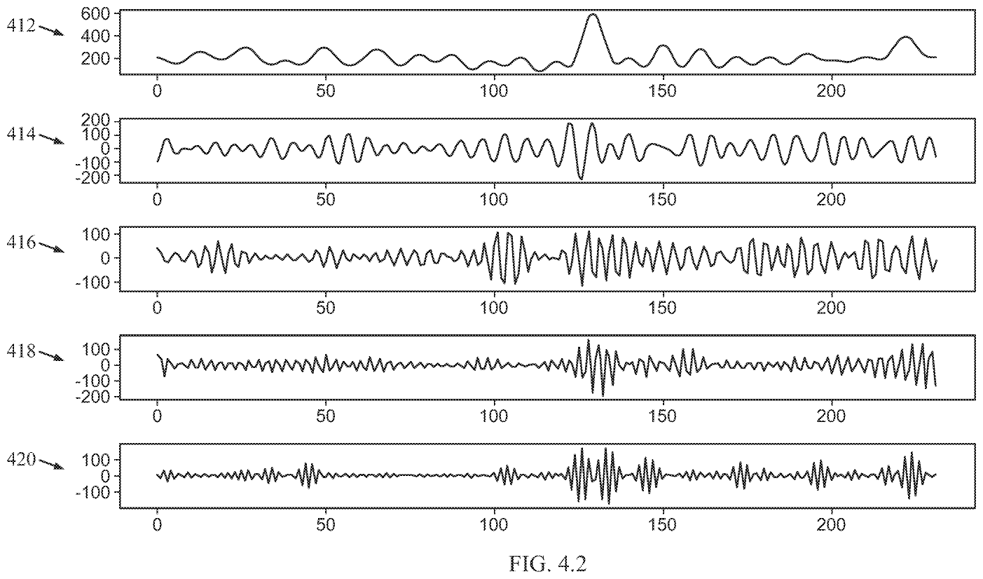

In one or more embodiments of the invention, the order processing system (130) (and/or any components illustrated within) may be implemented as one or more computing devices (e.g., 400, FIG. 4). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the order processing system (130) (and/or any components illustrated within) described throughout this present disclosure.

Alternatively, in one or more embodiments of the invention, the order processing system (130) (and/or any components illustrated within) may be implemented as logical devices. A logical device may utilize the computing resources of any number of computing devices to provide the functionality of the order processing system (130) (and/or any components illustrated within) described throughout this present disclosure.

In one or more embodiments, the deployment of the processing agents (136) is managed by an agent deployment manager (132). In one or more embodiments, the agent deployment manager (132) includes functionality for assigning each of the order processing agents (136) to service the client devices (110) in accordance with the functionality of the order processing system (130) discussed throughout this disclosure. The agent deployment manager (132) may make determinations for when to boot up the order processing agents (136), when to assign each of the processing agents (136) on standby, and/or when to reduce the number of processing agents (136) providing the services of the order processing system (130). Further, the agent deployment manager (132) may initiate the booting or powering down of the processing agents (136) in accordance with the aforementioned determinations.

To make such determinations, the agent deployment manager (132) may utilize the functionality of the order forecasting manager (134). While illustrated as a separate entity, the order forecasting manager (134) may be a component of the order processing system (130) without departing from the invention. The order forecasting manager (134) may include functionality for generating order forecasts for a given period of time. The order forecasts may be generated as forecasting sequences which may be represented as, for example, graphical Fourier transform. The forecasting sequences may represent outputs of an expected volume of orders for a point in time. In one or more embodiments, the expected volume of orders for a point in time may be an estimated average number of orders that an epicenter of a corporate entity is predicted to process over a predefined period of time (e.g., a week). In one or more embodiments, an epicenter of a corporate entity is a logical partitioning of entities within the corporate entity based on factors such as geographical regions in which the entities of the corporate entity operate. The entities may be, for example, employees and the computing devices used by the employees to provide the services (or enable the computing devices to provide said services) of the order processing system (130).

In one or more embodiments, the order forecasting manager (134) performs the generation of the forecasting models using the methods described in FIGS. 3 and 4.1-4.2. The order forecasting manager (134) may perform other methods to generate the forecasting models in accordance with one or more embodiments of the invention.

In one or more embodiments of the invention, the order forecasting manager (134) (and/or any components within) may be implemented as one or more computing devices (e.g., 400, FIG. 4). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the order forecasting manager (134) (and/or any components within) described throughout this present disclosure including, for example, the method illustrated in FIG. 3.

Alternatively, in one or more embodiments of the invention, the order forecasting manager (134) (and/or any components within) may be implemented as logical devices. A logical device may utilize the computing resources of any number of computing devices to provide the functionality of the order processing system (130) (and/or any components illustrated within) described throughout this present disclosure including, for example, the method illustrated in FIG. 3.

In one or more embodiments of the invention, the above-mentioned system (100) components may operatively connect to one another through a network (120) (e.g., a local area network (LAN), a wide area network (WAN), a mobile network, a wireless LAN (WLAN), etc.). In one or more embodiments, the network (120) may be implemented using any combination of wired and/or wireless connections. The network (120) may encompass various interconnected, network-enabled subcomponents (not shown) (e.g., switches, routers, gateways, etc.) that may facilitate communications between the above-mentioned system (100) components.

In one or more embodiments of the invention, the network-enabled subcomponents may be capable of: (i) performing one or more communication schemes (e.g., Internet protocol communications, Ethernet communications, communications via any security protocols, etc.); (ii) being configured by the computing devices in the network (120); and (iii) limiting communication(s) on a granular level (e.g., on a per-port level, on a per-sending device level, etc.).

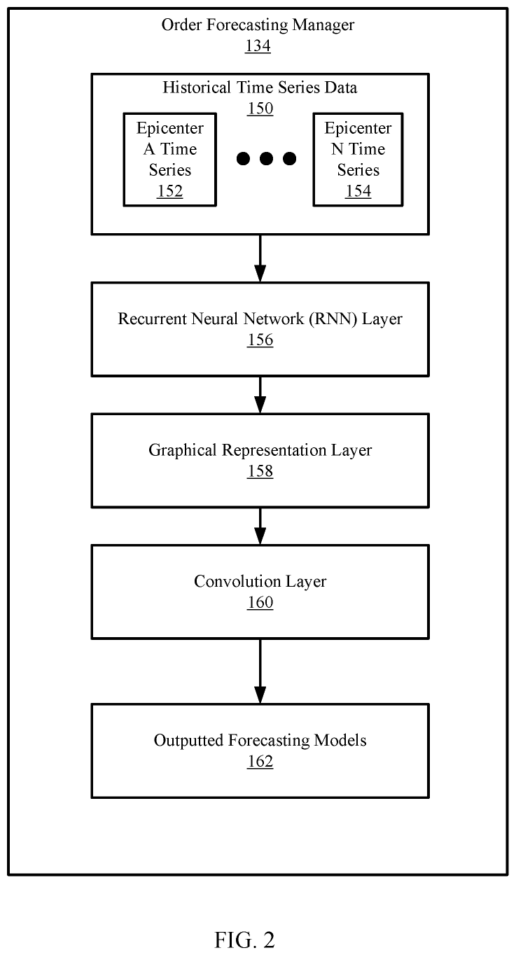

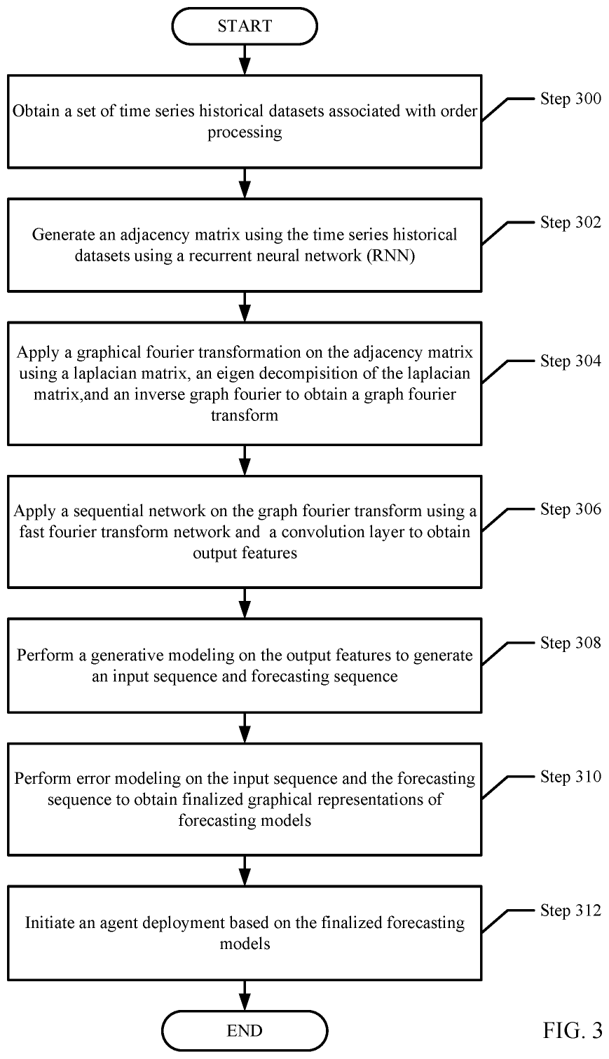

FIG. 2 shows a diagram of a order forecasting manager (134) in accordance with one or more embodiments. In one or more embodiments, the order forecasting manager (134) obtains historical time series datasets (150) from, for example, the order processing system (130, FIG. 2). The historical time series datasets (150) (also referred to as time series datasets) may specify a relationship between points in time and the corresponding number of orders for a period of time. As discussed above, the time series datasets includes combinations of both independent and identically distributed (IID) and non-IID data. In one or more embodiments, IID data refers to data that follows detectable patterns or trends. The patterns may be based on time seasons, based on expected periodic nature of order purchases, or based on any other internal or external factors without departing from the invention.

In one or more embodiments, each time series dataset (152, 154) is associated with an epicenter. As discussed above, an epicenter of a corporate entity is a logical partitioning of entities within the corporate entity based on factors such as geographical regions in which the entities of the corporate entity operate. The epicenters may each track their order processing information (e.g., number of orders for a given point in time) and provide an epicenter time series dataset (152, 154) to be used for the order forecasting models.

In one or more embodiments, to generate the outputted forecasting models (162), the timeseries datasets (150) may be processed using a RNN layer (156), a graphical representation layer (158), and a convolution layer (160). In one or more embodiments, the RNN layer (156) is a neural network algorithm that includes processing sequential data (e.g., a time series dataset (152, 154)) and outputting a sequential output. In one or more embodiments of the invention, the sequential output generated by the RNN layer (156) is an adjacency matrix. In one or more embodiments, an adjacency matrix is a data structure represented as a N×N matrix that relates an adjacency metric value each pair of items of a set of N items. The items may each be a time series dataset (152, 154).

In one or more embodiments, the adjacency matrix may be input into the graphical representation layer (158) and the convolution layer (160) that process the adjacency matrix and the time series datasets (150) in accordance with FIG. 3 to generate output features. The output features may be processed using an error modeling in accordance with FIG. 3 to generate the output forecasting models (162). The output forecasting models (162) may each be a graphical representation of the number of orders for an epicenter for previous and future periods of time. The output forecasting models (162) may each associate a previous or future point in time to a predicted number of orders that are expected to be processed during the corresponding point in time. An agent deployment manager (132, FIG. 1) may use the output forecasting models (162) to determine a number of agents to deploy for a given epicenter of the order processing system (130). For additional details regarding the generation of the output forecasting models (162) (also referred to as outputted forecasting models or forecasting models), refer to FIG. 3.

FIG. 3 shows a flowchart of a method of generating forecasting models in accordance with one or more embodiments of the invention. The method shown in FIG. 3 may be performed by, for example, an order forecasting manager (e.g., 134, FIG. 1). Other components of the system in FIGS. 1-2 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

Turning to FIG. 3, in step 300, a set of time series historical datasets are obtained. In one or more embodiments, the set of time series datasets are obtained from the order processing systems. As discussed above, each time series dataset may be associated with an epicenter. Further, the obtained time series datasets may include any combination of independent and identically distributed (IID) data and non-IID data.

In step 302, an adjacency matrix is generated using the time series historical datasets using a recurrent neural network (RNN). As discussed above, the adjacency matrix is a data structure represented as a N×N matrix that relates an adjacency metric value each pair of time series datasets of a set of N datasets. The adjacency metric values may be determined using the RNN layer discussed above.

In step 304, a graphical Fourier transformation is applied on the adjacency matrix using a Laplacian matrix, an Eigen decomposition of the Laplacian matrix, and an inverse graph Fourier to obtain a graph Fourier transform of the time series datasets. In one or more embodiments, a Laplacian matrix is a matrix representation of a graph or group of graphs. The Laplacian matrix may be generated using the following equation: L=I_N−D\hat{ }(−½)A*D\hat{ }(½). In this equation, D represents a degree matrix being a sum of rows of A (the adjacency matrix), N is a number of time series datasets, and I is an additional matrix. After calculating the Laplacian matrix L, an Eigen decomposition of the Laplacian matrix is performed to obtain a N×T matrix, where T is a number of time series data points per time series datasets. Further, an inverse graph Fourier transform may be generated by multiplying the inverse of the N×T matrix with the Eigen decomposition of the Laplacian matrix. The result of these equations may be a graph Fourier transform of one or more of the time series datasets.

In step 306, a sequential network is applied on the graph Fourier transforms using a fast Fourier transform network and a convolution layer to obtain output features. In one or more embodiments, the output of graph Fourier transform performed in step 304 is fed to a discrete Fourier transform layer that converts time series domain data to frequency domain and perform one-dimensional convolution and followed by a gated linear unit which results in converting the data back to time domain from frequency domain. This sequential network layer helps in capturing temporal and spatial features within the time series data. The output converted data may include output features.

In step 308, a generative modelling is performed on the output features to generate an input sequence and one or more forecasting sequences. In one or more embodiments, the output features generated in step 306 are fed to an inverse graph Fourier transform layer. The output from this layer may be used as a hidden representation for the decoder. In one or more embodiments, the decoder portion of the generative modelling generates the input sequence of the time series data. The hidden representation is used as a hidden state to the RNN to generate the output sequence.

In step 310, an error modelling is performed on the input sequence and the forecasting sequences to obtain finalized graphical representations of the forecasting models. In one or more embodiments, the error modelling is a combination of the combined loss function used for the backpropagation. The loss function is the combination of root mean squared error of the predicted next time stamp and a Kullback-Leibler (KL) divergence of the generated output sequence of the decoder of the auto-encoder and input sequence. As discussed throughout this disclosure, the forecasting models may provide an output of a number of predicted orders based on an input point in time.

In step 312, an agent deployment is initiated in accordance with the finalized forecasting models. In one or more embodiments, the agent deployment may be initiated such that the number of available agents for an upcoming point in time is increased if the forecasting models indicate a larger number of orders. Further, the number of agents may be decreased for a future point in time in which the forecasting models indicate a relatively low number of orders for the upcoming point in time.

To further clarify embodiments of the invention described throughout this disclosure, a non-limiting example is provided in FIGS. 4.1-4.2.

### EXAMPLE

Consider a scenario in which an order processing system for a business includes five epicenters, separated by geographical locations. Each epicenter manages fluctuating volumes of orders on a weekly basis. The order processing system may benefit from predicting future volumes of orders based on historical data and based on the comparative behavior of the epicenters.

FIG. 4.1 shows a diagram that includes five historical time series datasets (402, 404, 406, 408, 410). The time series datasets (402, 404, 406, 408, 410) may each be graphical representations of the number of orders for a given point in time over a period of time approximately between February of 2022 and November of 2022. The time series datasets (402, 404, 406, 408, 410) may be obtained from a corresponding epicenter. The first time series dataset (402) corresponds to a number of orders for epicenter EMEA; the second time series dataset (404) corresponds to a number of orders for epicenter CID; the third time series dataset (406) corresponds to a number of orders for epicenter CID CAS OPC; the fourth time series dataset (408) corresponds to a number of orders for epicenter Channel; and the fifth time series dataset (410) corresponds to a number of orders for epicenter Compellent. The collection of five time series datasets (402, 404, 406, 408, 410) may be processed in accordance with FIG. 3 to generate output forecasting models.

FIG. 4.2 shows a diagram that includes five forecasting models (412, 414, 416, 418, 420). Similar to the historical datasets (402, 404, 406, 408, 410) illustrated in FIG. 4.1, each forecasting model (412, 414, 416, 418, 420) corresponds to an epicenter. The forecasting models (412, 414, 416, 418, 420) may be graph Fourier transformations where the output features are optimized in accordance with the method of FIG. 3. The forecasting models (412, 414, 416, 418, 420) may be used to forecast future numbers of orders based on an input point in time (e.g., a specific week after November 2022). Using the forecasting models (412, 414, 416, 418, 420), the order processing system may manage the deployment of order processing agents used for order processing such that more agents are deployed on weeks in which the volume of orders are estimated to be relatively high, and less agents may be deployed on weeks in which the volume of orders are estimated to be relatively low.

### End of Example

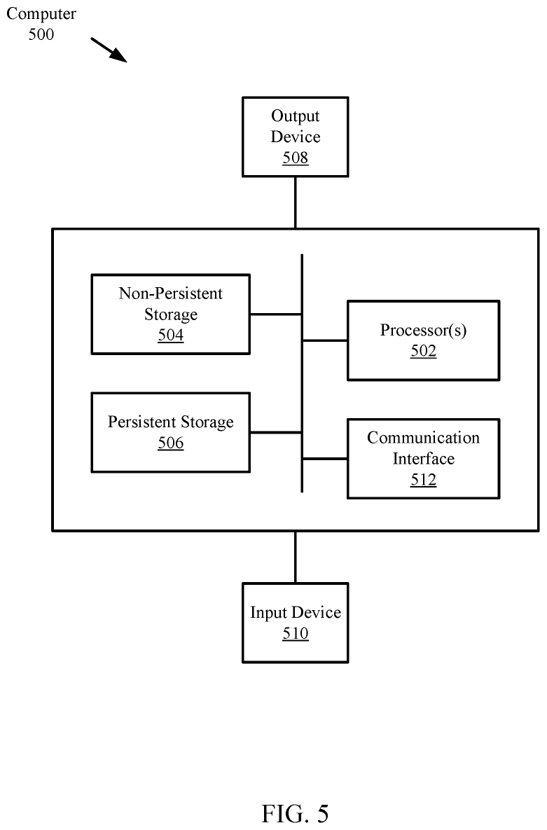

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may provide a system and method for optimizing resource use for processing orders. Embodiments disclosed herein provide methods and systems for forecasting future orders and using the forecasts to manage the resources reserved for such orders. For high numbers of orders forecasted, embodiments disclosed herein enable preparation of these high numbers by preemptively deploying additional resources (e.g., agents) for handling the expected high number of orders. Conversely, for low numbers of orders, the number of resources reserved for order processing may be reduced, thus preserving the resource consumption of the order processing system.

Thus, embodiments of the invention may address the problem of limited computing resources in a distributed system. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for managing order processing, the method comprising:
obtaining a set of time series datasets associated with the order processing for an order processing system;
generating an adjacency matrix using the set of time series datasets and using a recurrent neural network (RNN);
applying a graphical Fourier transformation on the adjacency matrix using a Laplacian matrix and an inverse graph Fourier to obtain a graph Fourier transform;
applying a sequential network on the graph Fourier transform using a fast Fourier transform network and a convolution layer to obtain output features;
performing a generative modeling on the output features to generate a forecasting sequence; and
initiating an agent deployment of a plurality of agents on the order processing system based on the forecasting sequence,
wherein the plurality of agents each provide services associated with order processing.

2. The method of claim 1, wherein applying the graphical Fourier transformation further uses an Eigen decomposition of the Laplacian matrix.

3. The method of claim 1, further comprising:
after performing the generative modeling, performing error modeling on an input sequence and the forecasting sequence to obtain a finalized forecasting model,
wherein the agent deployment is further based on the finalized forecasting model.

4. The method of claim 1, wherein each of the set of time series datasets is associated with an epicenter of an order processing system.

5. The method of claim 1, wherein the sequential network comprises applying a discrete frequency transform on the graph Fourier transform to obtain a frequency graph, and applying the convolution layer on the frequency graph and the graph Fourier transform to obtain the output features.

6. The method of claim 1, wherein the forecasting sequence indicates a high number of orders during a future period in time, and wherein performing the agent deployment comprises increasing a number of agents executing on the order processing system during the future period of time.

7. The method of claim 1, wherein the forecasting sequence indicates a low number of orders during a future period in time, and wherein performing the agent deployment comprises decreasing a number of agents executing on the order processing system during the future period of time.

8. A non-transitory computer readable medium comprising computer readable program code, which when executed by a computer processor enables the computer processor to perform a method for managing order processing, the method comprising:
obtaining a set of time series datasets associated with the order processing for an order processing system;
generating an adjacency matrix using the set of time series datasets and using a recurrent neural network (RNN);
applying a graphical Fourier transformation on the adjacency matrix using a Laplacian matrix and an inverse graph Fourier to obtain a graph Fourier transform;
applying a sequential network on the graph Fourier transform using a fast Fourier transform network and a convolution layer to obtain output features;
performing a generative modeling on the output features to generate a forecasting sequence; and
initiating an agent deployment of a plurality of agents on the order processing system based on the forecasting sequence,
wherein the plurality of agents each provide services associated with order processing.

9. The non-transitory computer readable medium of claim 8, wherein applying the graphical Fourier transformation further uses an Eigen decomposition of the Laplacian matrix.

10. The non-transitory computer readable medium of claim 8, further comprising:
after performing the generative modeling, performing error modeling on an input sequence and the forecasting sequence to obtain a finalized forecasting model,
wherein the agent deployment is further based on the finalized forecasting model.

11. The non-transitory computer readable medium of claim 8, wherein each of the set of time series datasets is associated with an epicenter of an order processing system.

12. The non-transitory computer readable medium of claim 8, wherein the sequential network comprises applying a discrete frequency transform on the graph Fourier transform to obtain a frequency graph, and applying the convolution layer on the frequency graph and the graph Fourier transform to obtain the output features.

13. The non-transitory computer readable medium of claim 8, wherein the forecasting sequence indicates a high number of orders during a future period in time, and wherein performing the agent deployment comprises increasing a number of agents executing on the order processing system during the future period of time.

14. The non-transitory computer readable medium of claim 8, wherein the forecasting sequence indicates a low number of orders during a future period in time, and wherein performing the agent deployment comprises decreasing a number of agents executing on the order processing system during the future period of time.

15. A system, comprising:
a processor; and
memory including instructions, which when executed by the processor, perform a method comprising:
obtaining a set of time series datasets associated with order processing for an order processing system;
generating an adjacency matrix using the set of time series datasets and using a recurrent neural network (RNN);
applying a graphical Fourier transformation on the adjacency matrix using a Laplacian matrix and an inverse graph Fourier to obtain a graph Fourier transform;
applying a sequential network on the graph Fourier transform using a fast Fourier transform network and a convolution layer to obtain output features;
performing a generative modeling on the output features to generate a forecasting sequence; and
initiating an agent deployment of a plurality of agents on the order processing system based on the forecasting sequence,
wherein the plurality of agents each provide services associated with order processing.

16. The system of claim 15, wherein applying the graphical Fourier transformation further uses an Eigen decomposition of the Laplacian matrix.

17. The system of claim 15, further comprising:
after performing the generative modeling, performing error modeling on an input sequence and the forecasting sequence to obtain a finalized forecasting model,
wherein the agent deployment is further based on the finalized forecasting model.

18. The system of claim 15, wherein the sequential network comprises applying a discrete frequency transform on the graph Fourier transform to obtain a frequency graph, and applying the convolution layer on the frequency graph and the graph Fourier transform to obtain the output features.

19. The system of claim 15, wherein the forecasting sequence indicates a high number of orders during a future period in time, and wherein performing the agent deployment comprises increasing a number of agents executing on the order processing system during the future period of time.

20. The system of claim 15, wherein the forecasting sequence indicates a low number of orders during a future period in time, and wherein performing the agent deployment comprises decreasing a number of agents executing on the order processing system during the future period of time.
